(19) United States
(12) Patent Application Publication
(10) Pub. No.: US 2010/0063788 A1
(43) Pub. Date: Mar. 11, 2010

(54) METHOD OF MODELLING THE INTERACTION BETWEEN DEFORMABLE OBJECTS

(75) Inventors: Thomas Ian Brown, Blackburn South (AU); David Healy, Kew (AU); Zorana Mayooran, Glen Waverley (AU); Corey Seligman, West Brunswick (AU)

Correspondence Address: BIRCH STEWART KOLASCH & BIRCH, PO BOX 747, FALLS CHURCH, VA, 22040-0747, US

(73) Assignee: MONASH UNIVERSITY, Victoria (AU)

(21) Appl. No.: 12/295,544

(22) PCT Filed: Mar. 30, 2007
(86) PCT No.: PCT/AU2007/000410

§ 371 Date: Nov. 24, 2009

(30) Foreign Application Priority Data
Mar. 30, 2006 (AU) 2006901643

(51) Int. Cl. G06G 7/48

(52) U.S. Cl. 703/6

(57) ABSTRACT

The present invention provides methods for determining a collision between a first deformable object and a second deformable object in a virtual reality simulation, the method including the steps of providing a first test capable of determining the proximity of the first object to the second object, providing a second test capable of determining the proximity of the first object to the second object, wherein the second test is more comprehensive than the first test, and wherein the second test is capable of being implemented once the first test returns a positive result. Since the more comprehensive test is implemented only when a collision is likely or imminent (as determined by the first test), the processor executing the simulation is not unduly burdened, and can devote resources to other tasks required by the simulation program.

### FIELD OF THE INVENTION

The present invention relates to computer generated models of physical objects. More specifically the invention provides an improved method of modelling the collision between computer generated models of deformable objects in a virtual environment.

### BACKGROUND

The computer has become an indispensable tool in modelling and simulation. As computational power increases, users and applications are demanding ever increasing levels of realism in these domains. This trend is particularly apparent in computer graphics where more sophisticated geometric shapes and physical objects are being modelled in the context of complex physical environments

In particular, the ability to model and manipulate deformable objects is essential to many applications. Approaches for modelling object deformation range from non-physical methods—where individual or groups of control points or shape parameters are manually adjusted for shape editing and design—to methods based on continuum mechanics—which account for the effects of material properties, external forces, and environmental constraints on object deformation.

Deformable object modelling has been studied in computer graphics for more than two decades, across a range of applications. In computer-aided design and computer drawing applications, deformable models are used to create and edit complex curves, surfaces, and solids. Computer aided apparel design uses deformable models to simulate fabric draping and folding. Deformable models have been used in animation and computer graphics, particularly for the animation of clothing, facial expression, and human or animal characters.

A constraint in the development of useful computer-based deformable models has always been the limitations imposed by the computer hardware of the day. This is especially problematic where the model is a dynamic model that is to be represented in real-time.

The interaction between deformable objects is complex and computationally expensive. During a simulation two or more deformable objects often need to “physically” interact when they collide (for example if a first object is dropped onto a second object). Collision detection is of paramount importance for many applications in computer graphics and visualization. Typically, the input to a collision detection algorithm is a large number of geometric objects comprising an environment, together with a set of objects moving within the environment. In addition to determining accurately the contacts that occur between pairs of objects, one needs also to do so at real-time rates. Applications such as haptic force-feedback can require over 1000 collisions.

### Minimally Invasive Surgery

While the real-time implementation problem applies to many applications for computer modelling, one area that has received considerable attention is in the modelling of human anatomy for the purposes of implementing surgical simulations. Flight simulators have been used to train pilots in complete safety for fifty years. By contrast, surgical simulators are now only being used to train surgeons in techniques used across a range of procedures. While traditional open surgery requires a great deal of skill to master, minimally invasive surgical techniques are even more difficult to learn.

Surgery in any form is a stress on the body. With traditional open surgery, the incision itself imposes additional risk of infection, trauma, and recovery time upon a patient, beyond that imposed by the condition giving rise to need for surgery. Advances in miniaturization of tools and implements, as well as video systems to view the inside of patients, have given rise to minimally invasive surgical techniques. In this epoch of surgery, small incisions are made in and the surgical implement is inserted into a vein, artery, or space between tissue. Tactile sensation imparted to the surgeon by the implement as it is inserted into the patient and visual display images from x-ray, television monitor or other system allowing an internal view of the body are then used to position the implement and complete the necessary task of the operation, be it repair of an organ such as the heart, removal of blocking tissue, the placement of a pacemaker lead, endoscopic surgery or other procedure. Due to the minimally invasive nature of this type of surgery, operations may be performed in a very brief period of time with less anaesthesia and hospitalization. Given the nature of this type of operating procedure there are a number of special considerations. Failure to properly orient the implement within the patient, or properly recognize the tissue through which the implement is passing, may result in the implement puncturing or rupturing a vein, artery, organ, or other internal tissue structure. Such an accident will almost certainly result in subjecting the patient to immediate emergency invasive surgery, morbidity, and perhaps death.

It is difficult for inexperienced surgeons to obtain a desired level of familiarity and competence leading to requisite certifications. Additionally, there are procedures that are performed infrequently. Without performing the operation repeatedly, the practitioner has no way of maintaining the high degree of skill that is obtained only through regular performance of the procedure. Further, it is not possible to implement new methods, operations, and procedures except on live patients. Accordingly, there is a need for an effective means to simulate real-life operations, so as to develop and maintain skill, and implement new techniques.

Minimally invasive surgical simulators based on computer technology have been known in the art for a number of years. The vast majority are not able to run in real-time, so that there is some lag between what the trainee does and what he sees on the computer screen. This is clearly less than optimal. Some simulators have the ability to run in real-time, but require vast processing power or parallel processing techniques. Such equipment is expensive and is not therefore widely available.

The uterine tube, ovarian ligament and ovary on each side of the uterus are freely moving objects that are in close proximity to one another. Collisions between them therefore occur very frequently. In the virtual environment, these collisions need to be accurately detected and handled. The collision detection algorithm and the anatomy motion model in this situation need to be different to those used when an instrument (ie a rigid object) interacts with anatomy. This difference arises from the fact that when two deformable bodies are colliding, the geometry of one of these bodies cannot simply be represented with one intersection segment, as would be the case where the collision includes on a rigid object such as a virtual instrument.

Throughout this specification, the example used will be the interaction between an ovary and a uterine tube as discrete anatomical objects in the context of a surgical simulation. This is for convenience only and is not intended to limit the invention to any specific application.

In light of the above, there is a clear need for a surgical simulator that is able to run in real-time on a computer that is inexpensive and easily available. The prior art has many examples of algorithms used to decide when two objects collide in a virtual environment. However, the prior art methods require a relatively large amount of processing time, and therefore require very sophisticated and expensive hardware to give reasonable real time performance. To this end, the present invention overcomes or alleviates a problem of the prior art by providing new algorithms defining the collision between deformable virtual objects.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed in Australia before the priority date of this application.

### BRIEF DESCRIPTION OF THE FIGURES

FIG. 1 shows distances and co-ordinates considered in the first and second tests. The distance O-P is used in the first test, while the points C are used in the second.

FIG. 2 follows on from FIG. 1 showing the first uterine tube segment intersected by the ovary.

FIG. 3 follows on from FIG. 2 showing the angle of rotation for the uterine tube after collision.

FIG. 4 follows from FIG. 3 showing rotation of the intersected segment and translation of remaining pivot points.

FIG. 5 follows on from FIG. 4 showing the next collided segment in the uterine tube.

FIG. 6 follows on from FIG. 5 showing the collided segment's angle of rotation and translation of pivots.

FIG. 7 follows on from FIG. 6 showing the next collided segment in the uterine tube.

FIG. 8 follows on from FIG. 7 showing the collided segment's angle of rotation and translation of pivots.

FIG. 9 follows on from FIG. 8 showing the final positions of the tube and ovary after collision.

FIG. 10 shows the situation where the uterine tube moves the ovary. Note that the first intersected segment has a minimum distance to one of the points on the ovary.

FIG. 11 follows on from FIG. 10 showing the angle of rotation of the ovary as a result of collision with the uterine tube.

FIG. 12 follows on from FIG. 11 showing rotation about the ovary axis as a result of collision with the uterine tube.

FIG. 13 follows on from FIG. 12 showing the final positions of the tube and ovary after collision.

### SUMMARY OF THE INVENTION

In a first aspect, the present invention provides a method for determining a collision between a first deformable object and a second deformable object in a virtual reality simulation, the method including the steps of providing a first test capable of determining the proximity of the first object to the second object, providing a second test capable of determining the proximity of the first object to the second object, wherein the second test is more comprehensive than the first test, and wherein the second test is capable of being implemented once the first test returns a positive result.

According to the present invention, the decision as to whether a collision between two deformable objects has occurred includes at least two steps. The first step includes a simple test to decide whether a collision is likely to occur, is imminent, or has already occurred. For example, the first test may monitor the distance from the centre of the first object to the centre of the second object. Once this distance becomes equal to or less than a predetermined value, the second more comprehensive test is implemented. The role of the second test is to more accurately determine whether a collision has occurred, and typically considers surface co-ordinates of one or both objects. In one form of the invention if the second test returns a positive result then a collision is confirmed, and the software directs the appropriate movements in the shape and/or position of either or both objects. Of course, more than one test may be implemented after the first test returns a positive result to more accurately determine whether a collision has occurred.

Applicants have found that the use of a first simple test to determine whether a collision between two deformable objects is likely to occur, is imminent, or has just occurred, followed by a more comprehensive test to more accurately determine a collision leads to significant savings in computer processor resources allocated to collision testing during the running of a dynamic simulation. The first test is generally running continuously throughout the application, while the second test is only implemented when the first test indicates that a collision is likely to occur or has just occurred.

The methods described herein are intended to be embodied in software designed for modelling interactions between deformable objects. Accordingly, in one aspect the present invention provides a computer executable program embodying a method for determining a collision described herein. In another aspect, the present invention provides a computer including a computer executable program described herein.

The methods, computer executable programs and computers described herein may be used in a wide range of fields requiring computer modelling of the collision of any two deformable objects. However, one particular use for which the present invention is applicable is for the modelling of collisions between biological tissues such as organs. This application will be useful in designing software for a virtual reality simulator that may be used in the training of surgeons. Accordingly, the invention also provides a method for training surgeons including a computer as described herein.

### DETAILED DESCRIPTION OF THE INVENTION

In a first aspect, the present invention provides a method for determining a collision between a first deformable object and a second deformable object in a virtual reality simulation, the method including the steps of providing a first test capable of determining the proximity of the first object to the second object, providing a second test capable of determining the proximity of the first object to the second object, wherein the second test is more comprehensive than the first test, and wherein the second test is capable of being implemented once the first test returns a positive result.

Applicants have discovered that the use of a “two-tiered” approach to collision testing avoids performing unnecessary detailed collision testing for every frame of the simulation. This approach is particularly useful where two deformable objects are so close in their resting state that their bounding volumes overlap for significant periods of time. The implementation of a simple primary test and a more complex secondary test reduces the computational burden on the processor(s) of the computer. This in turn leads to a simulation that is capable of running in approximately real-time, and capable of providing an acceptable degree of realism in modelling changes in the shape and/or position of the deformable objects in the virtual environment.

As used herein, the term “deformable object” refers to any virtual object that has an ability to change size and/or shape. A deformable object may include an association of rigid sub-objects that are linked to form a larger object. Deformable objects can be generated by any method known to the skilled person including finite element modelling and mass-spring modelling.

It will be clear that the terms “first deformable object” and “second deformable object” are used only to clarify the fact that two deformable objects are being considered. The terms may be interchanged in the context of this specification. The term “in or on” in this context are intended to mean within the interior of the deformable object or on the surface of the deformable object.

The method may include more than two tests in a cascade arrangement, with each further test being more detailed than the previous test. However, in one form of the method there are two tests, with a collision between the two objects being confirmed when the second test returns a positive result. If for example the method included three tests, then the third test would be implemented after the second test returned positive, and a collision would be confirmed once the third test returned a positive result.

The skilled person will be familiar with a range of tests that will be suitable as the first test. Essentially any test which is capable of determining the proximity of one object to another object will be useful in the context of the present invention. Proximity can be determined by any means such as by considering the distance from any co-ordinate of the first object to any co-ordinate of the second object.

In one embodiment of the method the first test does not consider a surface co-ordinate of the first or second deformable objects. In another embodiment of the method the first test considers the distance from one co-ordinate in or on the first deformable object, to one co-ordinate in or on the second deformable object. The first test may consider the distances between one co-ordinate in or on the first object and a plurality of co-ordinates in or on the second object.

In one embodiment of the method the first test includes generating a bounding volume for each object, and using a constraint relation to detect overlap between the bounding volumes. The bounding volume may be any volume type, however in one embodiment of the method is selected from the group consisting of a sphere, a cylinder, an oriented bounding box, an axis-aligned bounding box, a frustum, a wedge, a cone, a torus, an ellipsoid and a discrete orientation polytope. Of course, the constraint equation used will depend on the geometry of the objects under consideration. For example if the two objects are spheres, the constraint relation would consider the centre-to-centre distance between the spherical bounding volumes as compared with the sum of their radii. If the centre-to-centre distance is less than the sum of the radii of the two spherical bounding volumes, then the test returns a positive result. These examples of a suitable first test are computationally simple and require relatively little processor time.

The method requires that the second test is more comprehensive than the first test. The second test may consider the distances between more than one co-ordinate in or on the first deformable object, and more than one co-ordinate in or on the second deformable object. In one embodiment of the method the second test considers the distances between more than one co-ordinate on the first object and more than one co-ordinate on the second object. In another form of the method, the second test considers the distances between more than one co-ordinate in the second object and more than one co-ordinate on the first object. By considering more than one co-ordinate in or on the deformable objects, the second test is able to more accurately decide whether the objects (or any portion of the objects' surfaces) are required to change shape and/or position in the virtual environment. This provides a greater degree of realism in modelling the virtual interaction between the first and second objects.

The second test is triggered once the first test returns a positive result. The criteria by which the first test returns a positive result will depend on the specific situation. The skilled person will be able to identify a specific point at which the first test return positive which is suitable for a given application. For example, the first test may return a positive result during the movement of the first deformable object toward the second deformable object. When the two objects are distant to each other (and there is therefore a very low possibility of a collision occurring in the next second or several seconds of the simulation) the first test returns a negative result. As the distance between the first and second objects decreases, the first test continues to return a negative result. At a predetermined distance (typically a distance where a collision is likely or imminent) the first test returns a positive result thereby triggering the implementation of the second test. The second test will then detect with greater certainty that the two objects have in fact collided. This collision information is then used to realistically alter the shape and/or position of the objects in the virtual environment.

A further example includes the situation whereby the first and second deformable objects have already been involved in an earlier collision, and are resting in contact with each other. In this situation, the first test is returning a negative result, having been switched from positive upon confirmation of the earlier collision by the second test. The first test may also be returning a negative result because the simulation has just commenced, and the objects are in their starting resting state. The second test is not implemented in this situation since both objects are at rest, and there is therefore no requirement for a complex collision test to be running.

In one embodiment of the method the first test returns a positive result when a certain level of virtual force is exerted on the first object by the second object. One situation where this is relevant is where the first object is resting in contact with the second object. In this situation, it is considered that no collision is likely to occur between the first and second objects. However, this situation may be upset if a third object exerts a virtual force on the first object. Application of a virtual force to the first object may alter the proximity of the first object to the second object. The alteration in proximity may be detected by a change in the amount of overlap in bounding volumes of the first and second objects. The change in proximity may be such that the first test returns a positive result, in which case the second test is implemented. Where the second test is triggered, more complex calculations using surface co-ordinates are typically implemented allowing more accurate collision testing to be carried out across the surfaces of the colliding objects. The more accurate collision testing provides a greater degree of realism in representing the change in shape and/or position of the objects in the virtual environment.

From the foregoing, it will be understood that the term “collision test” is intended to include a test used to determine whether the surfaces of two separate objects have made virtual contact such that the objects are required to change shape and/or position in the virtual environment. It will also be understood that the term includes a test used to determine whether two objects that are already in virtual contact are required to change shape and/or position in the virtual environment, typically due to a virtual force acting on one or both of the objects. The common aspect in both situations is that the test determines whether or not a change in shape and/or position is required in the first and/or second objects as a result of some interaction between the two objects.

Without wishing to place any limitation on the invention described herein, a specific example in the area of virtual surgery will be considered, whereby an ovary and uterine tube co-exist in a virtual environment. In this example, the first test could involve determining the distance between the centre of the bounding volume of the ovary and the centre of the bounding volume of each segment of the fallopian tube. In this example, the first test would return a negative result if the fallopian tube was remote from the ovary or resting on the ovary. However, if a virtual instrument exerted sufficient force on the tube when the tube was resting on the ovary, the distance between the centre of the ovary and the centre of at least one segment of the tube will decrease to 90% or less of the distance at the resting state. With the decrease in distance, the first test will return a positive result thereby triggering implementation of the second test.

When the second test confirms a positive result, a collision is confirmed and the software implements a subroutine to change the shape and/or position of the first and/or second objects in the virtual environment.

From the foregoing, it will be clear to the skilled person that the invention will have use when the deformable objects are at rest and in contact. Because the bounding volumes of the first and second objects may be overlapping at rest, continually performing complex collision testing is unnecessary. Accordingly, the second more complex test is not implemented until the first test returns a positive result. This advantage is useful in the context of a surgical simulation where, for example, an ovary is resting on a uterine tube. The two objects are not moving or subject to any virtual force (except for gravity), their bounding volumes are overlapping, and the surfaces of the objects are in contact. In this state it is not necessary to perform a complex collision test that would be required to realistically model the shape and/or position of the two deformable objects. A more complex test would become necessary if for example an instrument pushed the ovary, thereby increasing the overlap in bounding volumes. In this scenario, the movement of the ovary would affect the shape and/or position of the tube as a result of the transference of force. Thus, it is possible to set a certain threshold of overlap, over which the second test is triggered.

The invention will also have use when the two objects are not even in contact. If two objects are spatially separate (and their bounding volumes are not overlapping) there is no point in using complex collision testing required to model the collision of deformable objects. The second more comprehensive test is implemented only once the first test returns a positive result. This approach saves considerably in processing time and results in faster frame rates.

The second test is more comprehensive than the first and is only implemented once the first test returns a positive result. The more comprehensive test is designed to more accurately detect a collision than the first test. Therefore, the second test may have more input parameters than the first test, or more complex input parameters than the first test, or involves more equations, or more complex equations, or more calculations, or more complex calculations than the first test in assessing whether or not a collision has occurred or is likely to occur.

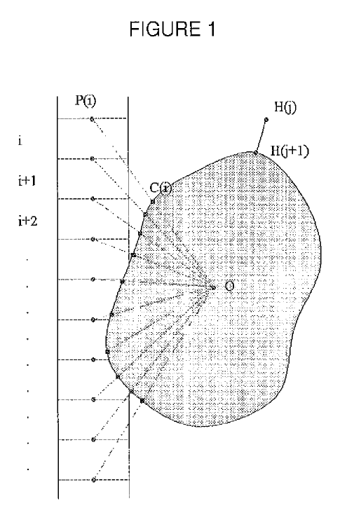

As discussed supra, the role of the second test is to provide a more realistic model of the collision between the two objects. Using the example of an ovary and uterine tube the second test may involve defining an intersection line from the largest segment in one object (ie. ovary) to the coordinate system origins of the segments in the other object (ie. uterine tube). Each of these lines intersected the ovary's geometry, thereby producing a group of points defining an outline of the ovary's surface at the collision site (see FIG. 1).

The second more comprehensive test only triggers once a predetermined level of overlap between the two objects is detected by the first test. In one embodiment of the method the overlap is considered in terms of a percentage of the radius of the bounding volume of the smaller of the two objects. In one embodiment of the method, the percentage is about 10% to about 20% overlap.

In an alternative embodiment of the method, the overlap threshold necessary to trigger the second test is defined by the bounding volume radius of the first object and the periphery of the bounding volume of the second object. If the periphery of the second object overlaps more than a predetermined percentage of the bounding volume radius of the first object then the second test is triggered.

This approach can be further explained using the example of an ovary and a pivoted uterine tube. In this application a collision test between deformable bodies may be based on the pivot points of segments. Because the bounding volumes of the hybrid and pivoted objects are overlapping at rest, it is unnecessary to implement the second test. Thus, while all anatomy is in its initial (resting) state, distances between the centre of the bounding sphere of the ovary and each of the pivot points of all segments on the tube are found. If any of these distances reduce to below 90% of their initial value, the second (more comprehensive) test is triggered.

It is contemplated that the method of the present invention is embodied in the form of a computer executable program. The skilled person will be able to implement the methods described herein in one of a number of many programming languages known in the art. Such languages include, but are not limited to Fortran, Pascal, Ada, Cobol, C, C++, Eiffel, Visual C++, Visual Basic or any derivative of these. The program may be stored in a volatile form (for example, random access memory) or in a more permanent form such as a magnetic storage device (such as a hard drive) or on a CD-ROM.

In one embodiment of the method the first and/or second object are modelled using a software package selected from the group including Wavefront/Alias Maya, 3DstudioMax or any other software package suitable for modelling 3D organic/curved shapes known to the skilled artisan.

The present invention also provides a computer including a computer executable program described herein. In one embodiment of the method the computer has a central processing unit having a central processing unit with a clock speed lower than approximately 100, 200, 300, 400, 500, 600, 700, 800, 900, 1000, 1100, 1200, 1300, 1400, 1500, 1600, 1700, 1800, 1900 or 2000 MHz. In one embodiment of the method the central processing unit of the computer is selected from the group consisting of Pentium 1, Pentium 2, Pentium 3, Pentium 4, Celeron, MIPS, RISC, or R10000. It is an advantage of the invention that complex simulations may be executed on a computer having slower speeds or less sophisticated processors, as compared with methods of the prior art. This is because the use of more comprehensive collision testing is used only when necessary during the simulation.

In one embodiment, the computer executable program is capable of running in approximately real-time on a computer. The realism of the visual component of a virtual reality computer simulation is reliant on the ability of the modelling method to refresh the visual display at a sufficiently high number of frames per second. In one embodiment of the method, frame rates of at least 24 frames per second are provide. In another embodiment frame rates of at least 30 frames per second are provided.

In one embodiment, the method is a component of a virtual reality system. Virtual reality systems based on computer technology are well known in the art. Such systems generally include a central processing unit containing all computer hardware and software required to effect the simulation. Also included are input devices such as motion sensors and output devices such as a visual display unit.

It should be understood that the present invention is applicable to a wide variety of virtual reality applications where collision testing is involved.

In one embodiment, the virtual reality system is used for training in surgical techniques. The virtual reality systems of the present invention may be used in the training of a range of surgical techniques. However, in one embodiment of the invention the virtual reality systems are used in the training of gynecological surgery, gall bladder surgery, neurosurgery, thoracic surgery, eye surgery, and orthopedic surgery.

It is contemplated that the methods and/or virtual reality systems described herein may include other features such as a hierarchical segmented implementation of visual and tactile features including interactive touch whereby virtual objects can be felt when touched with virtual instruments.

The methods and/or virtual reality systems described herein may also include anatomical structures having pathological features that can be seen in the visual display unit, and felt via haptic feedback from the instruments. It is also anticipated that interactive movement of different anatomical organs could be implemented by segmenting the anatomical field into anatomical objects, each with different dynamic attributes.

The methods and/or virtual reality systems described herein may also incorporate interactive movement of different parts of an anatomical object by allowing a virtual instrument to interact with a segment of the anatomical object at the point of contact and then allowing neighbouring segments to move according to prescribed rules.

In another embodiment of the present invention the methods and/or virtual reality systems described herein may further include interactive touch—haptic feedback of different part of the anatomical object is achieved by allowing the virtual instrument to interact with a segment of the anatomical object at the point of contact and allowing the model to define the appropriate haptic feedback vector at that point.

The methods and/or virtual reality systems described herein may also include tissue pathology attributes applied to a group of segments of each anatomical object, with pathology providing an input to both the visual and tactile models as described above.

One form of the invention provides a virtual reality system representing the female pelvic anatomical field (as viewed by an endoscopic camera during surgery). This complex anatomical field, consists of a number of organs and structures, each with different visual, movement, tactile and disease characteristics. The simulation represents this complex field by segmenting the anatomy into anatomical objects (organs and other structures), and sub objects or segments of organs and structures. Visual, movement, tactile and disease properties are then attributed to a segment of the anatomy as represented by that segment of the model. Properties of a model segment can also be derived from the position or movement of adjacent segments.

As the segment of anatomy is moved (and felt) by endoscopic instruments the anatomical model will only need to move (or be felt) when the haptic instruments move into the region of the model in which that segment lies. Thus when an instrument approaches a particular segment of the model the movement and tactile attributes of that segment will become active. It is unnecessary for the whole organ or the whole model to move or be felt. Movement can however be conveyed from one segment to an adjacent segment if the rules enabling movement in that segment allow this to happen.

In relation to motion every segment has its bounding volume used to test against intersections with an instrument and other segments. Motion of objects is a superposition of rigid and deformable models. Rigid motion refers to the global motion of objects such as translation and rotation. In the case of tubular structures such as the uterine tubes and ligaments, these objects are sub-divided into rigid volumetric segments. When an instrument touches/intersects a particular segment, all other segments belonging to the same object move according to a pre-defined physical/mathematical model. Therefore, movement is restricted to an object (e.g. left uterine tube, uterus, right ovary, etc.) rather than the entire anatomical structure (e.g. reproductive organs as a single mesh).

As will be apparent to the skilled person, a model of deformable motion may be constructed such that the surface of the organ is a group of points/particles. This allows surface deformation resulting from interactions with a surgical instrument such as indentation and pulling is localised. Therefore effects of a deformation propagate from the point of contact with an instrument to all neighbouring points in the virtual organ lying within a pre-defined spherical volume determined by the force of contact. Hence, deformation may only affect a part of an object, rather than its entire mesh.

In one embodiment, the virtual reality system described herein is used in the training of a surgical technique. In one embodiment, the surgical technique is a minimally invasive technique such as endoscopic surgery. Thus, in certain embodiments of the method, the first and second objects are models of anatomical features of the human body. In one embodiment of the method the first and/or second object is an organ. In another embodiment, the organ is selected from the group including a fallopian tube, uterus, ovary and ovarian ligament.

The present invention also provides a method for training surgeons including a method and/or computer and/or virtual reality system described herein. The method for training may include other features well known in the art of teaching such as training manuals, lecture notes, practical demonstrations and the like.

### EXAMPLES

### Example 1

### Motion of the Colliding Anatomy—Ovary Moving the Uterine Tube

FIG. 1 is the first in a sequence demonstrating one embodiment of the invention whereby the uterine tube is stationary, and the ovary moves toward the tube. This first figure shows the instant where the first. The first test determines the proximity of the two objects by reference to the length of the lines O-P. When the two objects are distant, the length of lines O-P are all greater than a predetermined value, and the first test returns a negative result. As the ovary moves toward the tube, the length of the lines O-P decreases although the first test still returns a negative result so long as the length is still greater than a predetermined value. FIG. 1 shows the instant whereby at least one the lines O-P is equal to the predetermined value, and the first test returns a positive result.

At this point, the second test is implemented. The second test in this embodiment considers the points C on the surface of the ovary, and the relationship of these points with the surface of the ovary in deciding whether the two objects have collided, thereby necessitating changes to the either object's shape or position. Upon implementation of the second test, it is clear that a number of points C on the surface of the ovary are in fact overlapping with the wall of the tube and a collision has therefore already occurred. This collision was not confirmed with the simple first simple test, but is now confirmed by the more complex second test.

Once a collision between the uterine tube and ovary was confirmed, the collided are moved out of each other's geometries. At this stage, a decision must be made as to which object should be causing the other to move.
If the instrument pushed the tube and not the ovary, then the tube would move the ovary, and vice versa.
If the instrument pushed both the tube and the ovary, then the one first touched by the instrument would push the other.
If the tube fell onto the ovary, the tube would move the ovary, and vice versa.

The motion models were based on two situations: one when the tube moved the ovary and the other when the ovary moved the tube. These were based on the same principles but were applied differently due to the size differences of their segments.

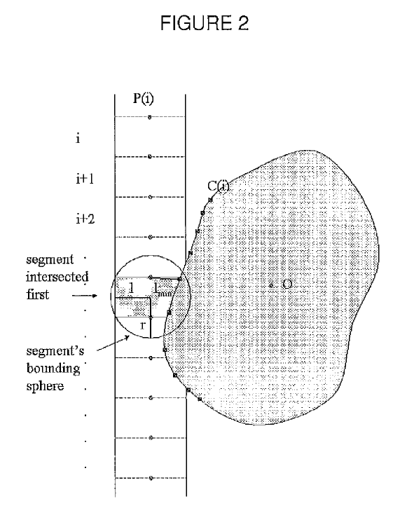

For each pivot point of the segments in the uterine tube, the distance to the intersected points on the surface of the ovary was found. If the minimum of these distances was less than 0.8 times the radius of the segment's bounding volume, a collision was confirmed (see FIG. 2)
if segment n is intersected by the ovary
for all segments i

1=|P(n)−C(i)|

if (1<1ₘᵢₙ)

1ₘᵢₙ=1.

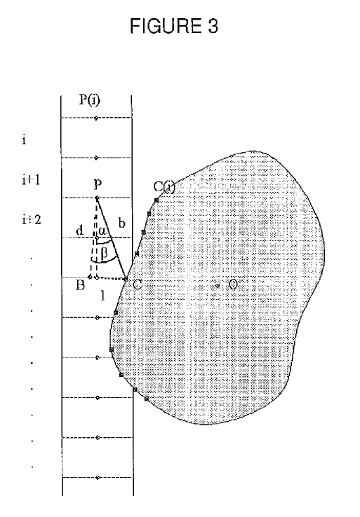

The first intersected segment of the uterine tube was chosen to rotate about the pivot point of the second segment above it in hierarchy (see FIG. 3).
let r=segment's bounding-sphere radius
l should be 0.8r so that there is no overlap between the segment and the ovary

b=|C−P|

d=|B−P|

l=0.8r

using the triangle identity c²=a²+b²−2ab cos C

1²=b²+d²−2bd cos β

∴β=arcos((b²+d²−l²)/2bd)

(C−P)(B−P)=|C−P||B−P|cos α

α=arcos((C−P)(B−P)/bd)

the segment should therefore be rotated by ((β−α) so that l=0.8r

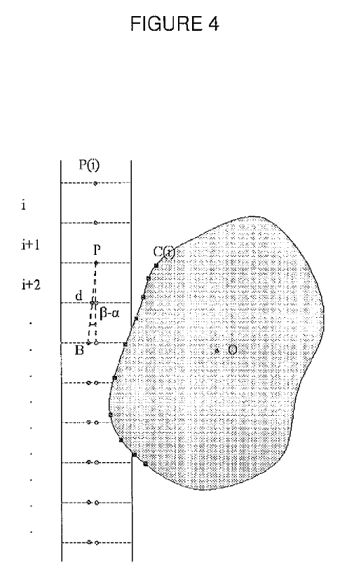

The reason the pivot of the second segment above was chosen over the first was that the bending of the tube would be less pronounced and thus more natural. The intersected segment's pivot point was rotated about its chosen point of rotation so that the distance between the segment's new pivot and its corresponding point on the surface of the ovary would be 0.8 times the radius of the segment's bounding volume (see FIG. 3). Pivot points of segments beneath the one rotated were translated across (see FIG. 4)

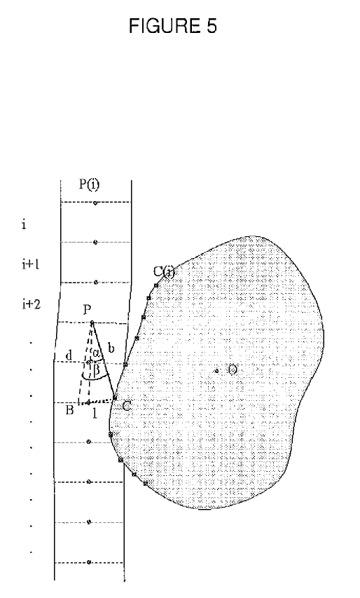

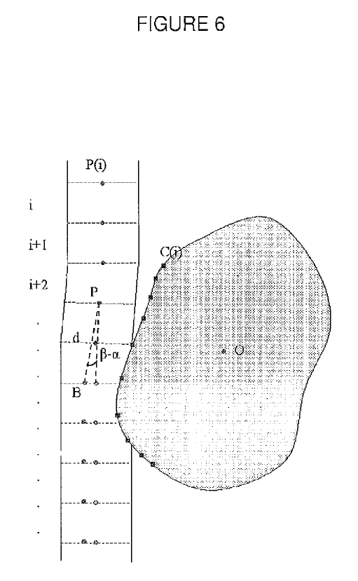

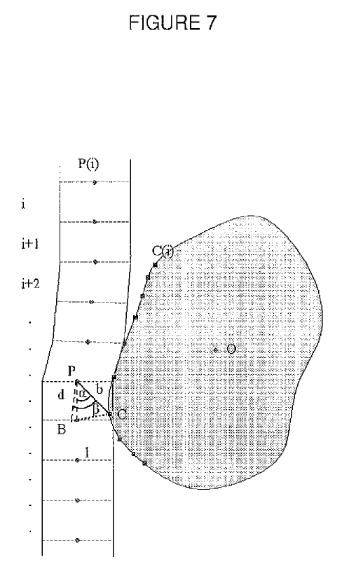

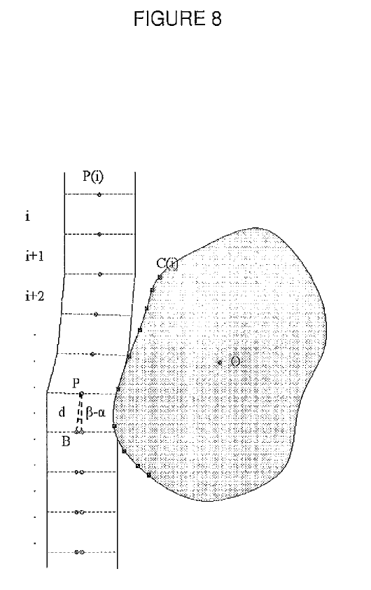

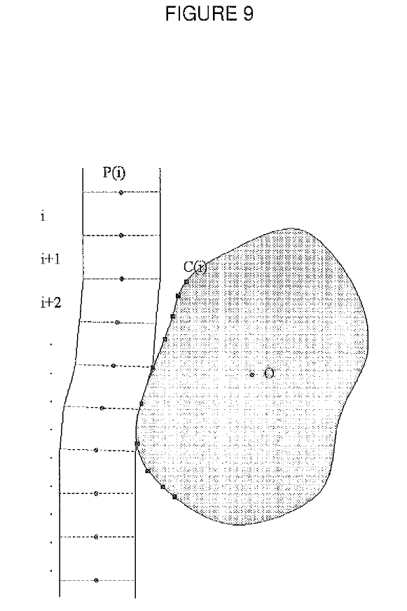

The same process was repeated again until no more collisions were reported and all segments in the uterine tube previously collided with the ovary were on its surface. The process of rotating collided segments is shown in FIGS. 5 to 8. The final solution is presented in FIG. 9.

### Example 2

### Motion of the Colliding Anatomy—Uterine Tube Moving the Ovary

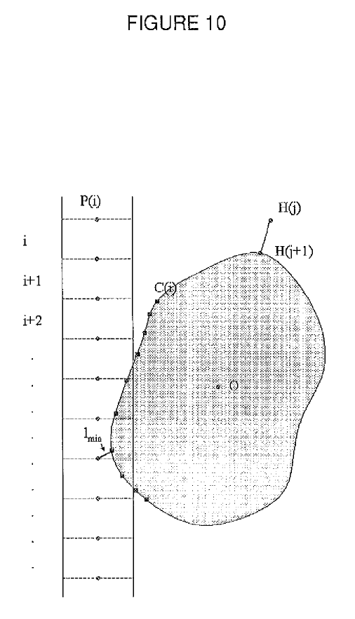

For each pivot point of the segments in the uterine tube, the distance to the intersected points on the surface of the ovary was found. The minimum of all these distances located the segment that had the largest portion of its geometry within the geometry of the ovary (see FIG. 10). By moving onto the surface of this segment, the ovary also moved out of the geometry of all the other segments in the uterine tube.

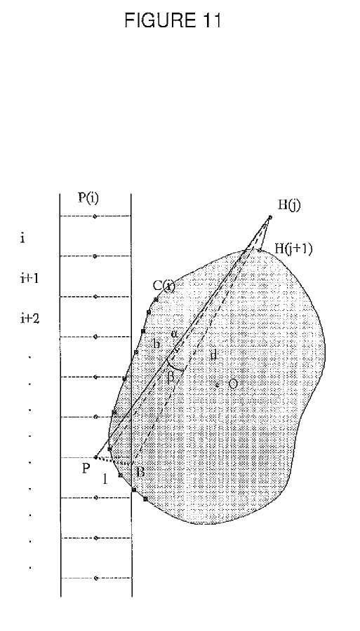

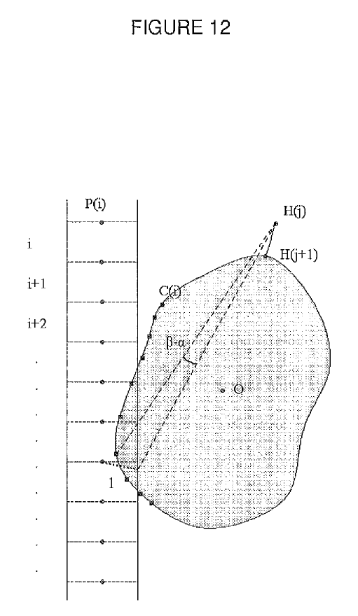

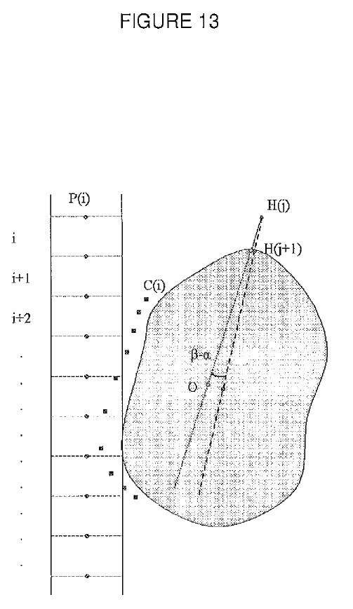

If the minimum distance between the intersected segment's pivot and a point on the surface of the ovary was smaller than 0.8 times the radius of that segment's bounding sphere, the segment and the ovary were intersecting (see FIG. 10). The ovary had to be rotated so that the distance between these two points was 0.8 times the radius of the segment's bounding sphere (see FIG. 11). The ovary was then rotated about its axis by the angle shown in FIG. 12. This rotation of the ovary produced the final solution where the ovary and the tube were no longer intersecting (see FIG. 13).

Finally, it should be appreciated that many variations, modifications and alterations may be made to the above described composition without departing from the spirit or scope of the invention.

1. A method for determining a collision between a first deformable object and a second deformable object in a virtual reality simulation, the method including the steps of providing a first test capable of determining the proximity of the first object to the second object, providing a second test capable of determining the proximity of the first object to the second object, wherein the second test is more comprehensive than the first test, and wherein the second test is capable of being implemented once the first test returns a positive result.

2. A method according to claim 1 wherein the second test, in comparison with the first test, requires more input parameters or more complex input parameters in assessing whether or not a collision has occurred or is likely to occur.

3. A method according to claim 1 wherein the second test, in comparison with the first test, involves more calculations or involves more complex calculations in assessing whether or not a collision has occurred or is likely to occur.

4. A method according to claim 1 wherein the second test is more computationally intensive than the first test in assessing whether or not a collision has occurred or is likely to occur.

5. A method according to claim 1 wherein the proximity is determined by considering the distance from any co-ordinate of the first object to any co-ordinate of the second object.

6. A method according claim 1 wherein the first test does not consider a surface co-ordinate of the first object or the second object.

7. A method according to claim 1 wherein the first test considers the distance from one co-ordinate in or on the first deformable object, to one co-ordinate in or on the second deformable object.

8. A method according to claim 1 wherein the first test includes generating a bounding volume for the first and second objects, and detecting the presence or absence of an overlap between the bounding volumes.

9. A method according to claim 1 wherein the second test is implemented when a predetermined level of overlap between the two objects is detected by the first test.

10. A method according to claim 1 wherein at least one bounding volume is selected from the group consisting of a sphere, a cylinder, an oriented bounding box, an axis-aligned bounding box, a frustum, a wedge, a cone, a torus, an ellipsoid and a discrete orientation polytope.

11. A method according to claim 8 wherein the overlap in bounding volumes is determined by a constraint equation.

12. A method according to claim 8 wherein the overlap is considered in terms of a percentage of the radius of the bounding volume of the smaller of the two objects.

13. A method according to claim 12 wherein the percentage overlap is from about 10% to about 20%.

14. A method according to claim 1 wherein the second test considers the distances between more than one co-ordinate in or on the first deformable object, and more than one co-ordinate in or on the second deformable object.

15. A method according to claim 1 wherein the second test considers the distances between more than one co-ordinate on the first object and more than one co-ordinate on the second object.

16. A method according to claim 1 wherein the second test considers the distances between more than one co-ordinate in the second object and more than one co-ordinate on the first object.

17. A method according to claim 1 wherein the first test returns a negative result when the first and second deformable objects are already in contact with each other.

18. A method according claim 1 wherein when the second test returns a positive result, a collision is confirmed and the software implements a subroutine to change the shape and/or position of the first and/or second objects.

19. A method according to claim 1 wherein the first and/or second object is generated by finite element modelling or mass-spring modelling.

20. A computer executable program capable of implementing a method according to claim 1.

21. A computer including a computer executable program according to claim 20.

22. A computer according to claim 21 capable of representing the virtual reality simulation in approximately real-time.

23. A computer according to claim 21 capable of representing the virtual reality simulation at a refresh rate of at least 24 frames per second.

24. A computer according to claim 21 capable of representing the virtual reality simulation at a refresh rate of at least 30 frames per second.

25. A virtual reality system including a computer according to claim 21.

26. A method for training surgeons including a virtual reality system according to claim 25.
